(19) United States
(12) Patent Application Publication
(10) Pub. No.: US 2017/0091760 A1
(43) Pub. Date: Mar. 30, 2017

(54) Device and method for currency conversion

(71) Applicant: Travelex Currency Services Inc., New York, NY (US)

(72) Inventors: Keith Baumwald, New York, NY (US); DeAndre Purdie, Brooklyn, NY (US); Milovan Jovicic, Mladenovac (RS)

(21) Appl. No.: 14/756,624

(22) Filed: Sep. 25, 2015

(51) Int. Cl. G06Q 20/38

(52) U.S. Cl. CPC G06Q 20/381

(57) ABSTRACT

An information processing method running on a mobile device for converting a textual representation of a currency amount from a base currency to a target currency is provided, including capturing an image of text including a currency amount from a selected region in a larger portion of text displayed on the display; determining the parameters of a region of interest by detecting one or more contours of individual characters located in the captured image; defining an analysis image by the mobile device by selecting a portion of the captured image using the parameters of the region of interest; recognizing a series of non-numerical symbols and numbers in the analysis image by the mobile device via optical character recognition; adding, by the mobile device, the recognized non-numerical symbols and the numbers as an entry in an array; selecting one of the entries from the array; converting the numerical amount from the base currency to the target currency; and overlaying in the selected region, the converted numerical amount in the target currency.

### CROSS-REFERENCE TO RELATED APPLICATIONS

This application claims priority to U.S. Provisional Application No. 62/055,401, filed Sep. 25, 2014, which is incorporated herein in its entirety.

### BACKGROUND OF THE DISCLOSED SUBJECT MATTER

Field of the Disclosed Subject Matter

The disclosed subject matter relates generally to the field of currency conversion and particularly to mobile devices providing currency conversion techniques.

Description of Related Art

With the prevalence of international travel, individuals are increasingly faced with the inconvenience of making purchases using a local currency for which they are unfamiliar. Often the exchange rates can change with some frequency or the traveler is making multiple stops in the journey, and it thus becomes difficult for a traveler to keep track of currency exchange rates for rapid mental conversions on the fly.

The presence of smartphones, tablets and other “connected” devices provides such travelers with access to exchange rates via wireless access. However, such approaches fail to address the real-life concerns of the traveler in situations where a currency conversion is needed rapidly to assist the user in making commercial decisions in an unfamiliar and sometimes stressful environment.

First, a user may be faced with making choices about multiple products within a tight time constraint. For example, a traveler may be in a crowded restaurant and need to make a decision about selecting a particular food item from an extensive list. Merely having access to the exchange rate provides little assistance to the traveler to obtain an overview of the prices for numerous items for a rapid comparison.

Second, in the scenario where the traveler is seeking prices from an extensive list, the mere provision of a currency exchange rates, out of context, may provide little useful information if the traveler cannot keep track of the particular item (in such extensive list) for which a currency conversion was sought. If the traveler has limited language capability in the particular language, such difficulty will be exacerbated.

Third, the time constraints in a typical scenario often do not allow the traveler to stop and manually perform calculations but require the traveler to maintain eye contact on the sign, list or document being reviewed to make a decision. For example, the traveler may be shopping and have multiple items in one hand, and performing extensive calculations and data entry are impracticable.

Fourth, a user may be traveling among multiple destinations, in which the base (local) currency will change throughout the particular journey. Such user is faced with frequently changing, e.g., reprogramming the base currency several times.

What is needed is an apparatus and a method for converting currency which does not require the user to individually calculate currency conversions for multiple products, to remember the particular item for which a conversion was sought, to change visual focus from the information or signage being viewed, and which allows the conversion to make practical use of the information in the text currently provided, such as currency symbols.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

Generally stated, the disclosed subject matter relates to apparatus and methods for mobile currency conversion which overcomes the limitations of the prior art.

In accordance with another aspect of the disclosed subject matter, an information processing method running on a mobile device for converting a textual representation of a currency amount from a base currency to a target currency is provided, which includes capturing an image of text including a currency amount from a selected region in a larger portion of text displayed on the display. The capturing is performed by an imagine capturing device, such as a camera, of the mobile device.

The mobile device determines the parameters of a region of interest by detecting one or more contours of individual characters located in the captured image. An analysis image is defined by the mobile device by selecting a portion of the captured image using the parameters of the region of interest.

A series of non-numerical symbols and numbers are recognized in the analysis image by the mobile device via optical character recognition. A subsequent step is adding, by the mobile device, the recognized non-numerical symbols and the numbers as an entry in an array. The above steps are repeated, and one of the entries from the array is selected for further processing.

The mobile device converts the numerical amount from the base currency to the target currency; and overlays in the selected region, the converted numerical amount in the target currency.

In some embodiments, the selected base currency is determined by recognition of a currency symbol in the non-numerical symbols. In some embodiments, the selected base currency is selected by the user. In some embodiments, the selected base currency is selected by geolocation data. In some embodiments, the target currency is selected by the user.

The image can be a frame of a real-time video stream.

In some embodiments, the information processing method further includes providing a highlighted region on the display for a user to select a region in a larger portion of text. Providing the highlighted region on the display can include allowing a user to manipulate the display to position a selected portion of text within the highlighted region.

In some embodiments, the highlighted region is a fixed area. In some embodiments, the highlighted region is user-selectable area.

In some embodiments, the recognition of a series of non-numerical symbols and numbers in the region of interest via optical character recognition includes providing a subset of characters for conversion to numbers. For example, the recognition of certain characters, e.g., “o” “O” “I” “I” “|” “1” can be biased towards recognition as numbers 0 and 1.

In accordance with another aspect of the disclosed subject matter, a mobile device is provided, which includes an image capturing device; a display; one or more processors; memory; and one or more programs, wherein the one or more programs are stored in the memory and configured to be executed by the one or more processors, the one or more programs including instructions for: capturing an image of text including a currency amount by the image capturing device of the mobile device from a selected region in a larger portion of text displayed on the display; determining the parameters of a region of interest by detecting one or more contours of individual characters located in the captured image; defining an analysis image by selecting a portion of the captured image using the parameters of the region of interest; recognizing in the analysis image via optical character recognition a series of non-numerical symbols and numbers; adding the recognized non-numerical symbols and the numbers as an entry in an array, repeating the capturing, determining, defining, recognizing, and adding steps and selecting one of the entries from the array; converting the numerical amount from the base currency to the target currency; and overlaying in the selected region of the display, the converted numerical amount in the target currency.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

FIG. 1 is a system diagram illustrating several components of an exemplary currency conversion device 10 in accordance with an embodiment of the disclosed subject matter.

FIG. 2 is a flow diagram of a currency conversion routine 100 in accordance with an embodiment of the disclosed subject matter.

FIG. 3 is a flow diagram of an image processing routine, in accordance with an embodiment of the disclosed subject matter.

FIG. 4 illustrates an exemplary currency conversion device in one stage of operation, in accordance with an embodiment of the disclosed subject matter.

FIG. 5 is a flow diagram of a routine for selecting a region of interest, in accordance with an embodiment of the disclosed subject matter.

FIG. 6 is a flow diagram of an optical character recognition routine, in accordance with an embodiment of the disclosed subject matter.

FIG. 7 is a flow diagram of a currency conversion routine, in accordance with an embodiment of the disclosed subject matter.

FIG. 8 is a flow diagram of a graphical overlay routine for displaying the converted currency text, in accordance with an embodiment of the disclosed subject matter.

FIG. 9 illustrates an exemplary currency conversion device in a later stage of operation, in accordance with an embodiment of the disclosed subject matter.

### DETAILED DESCRIPTION OF THE EXEMPLARY EMBODIMENTS

Reference will now be made in detail to the exemplary embodiments of the disclosed subject matter, examples of which are illustrated in the accompanying drawings. The method and corresponding steps of the disclosed subject matter will be described in conjunction with the detailed description of the system.

Generally stated, the disclosed subject matter relates to an apparatus and method for providing currency conversion. The disclosed subject matter is described below by reference to exemplary embodiments, but the disclosed subject matter should not be limited by such embodiments or examples provided. The disclosed subject matter, however, can be embodied in many different forms and carried out in a variety of ways. The exemplary embodiments that are described and shown herein are only some of the ways to implement the disclosed subject matter. Elements and/or actions of the disclosed subject matter may be assembled, connected, configured, and/or taken in an order different in whole or in part from the descriptions herein.

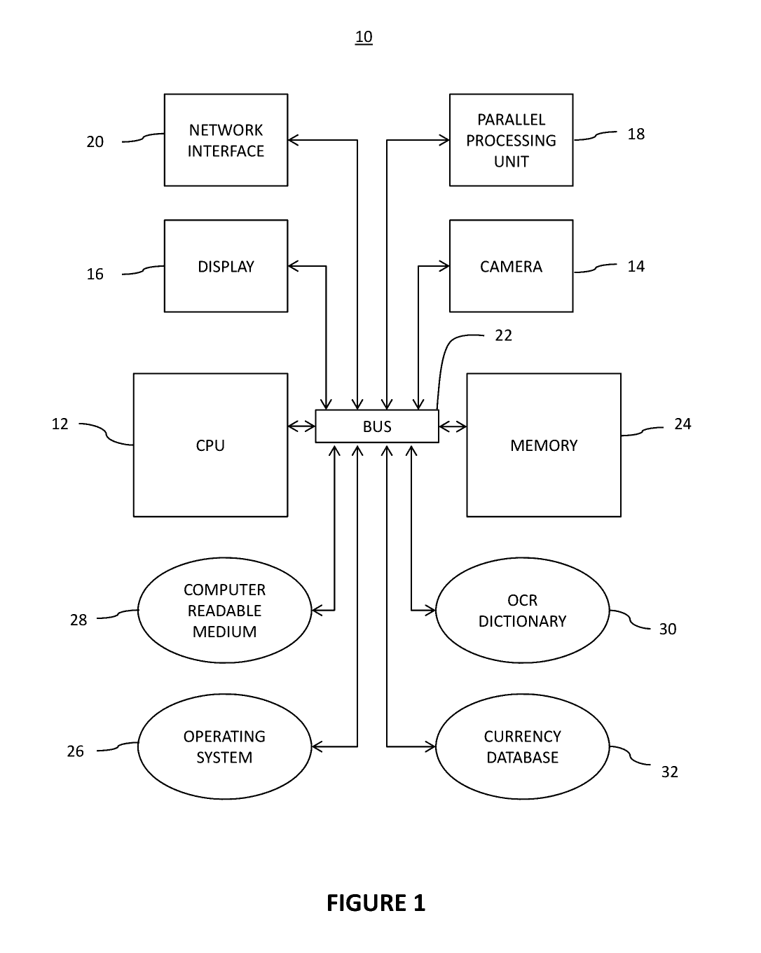

FIG. 1 illustrates an exemplary apparatus 10, which can be a mobile device, such as a smartphone or tablet. For convenience, in describing this exemplary embodiment, the device may be referred to as a “mobile device.” As will be described in greater detail below, the mobile device 10 includes a central processing unit (CPU) 12, an image capture device, such as a camera 14, and a display screen 16. A parallel processing unit 18 may be used for performing certain calculations. The CPU 12, camera 14, display 16, network interface 20 and parallel processing unit may be interconnected by a bus 22. The mobile device 10 is typically a connected device. As such, the device 10 includes a network interface 20, such as a cellular or Wi-Fi antenna, and associated hardware and software. Such interface 20 is useful for obtaining real-time currency conversion information. The mobile device 10 includes memory 24, typically including random access memory, read only memory and other storage devices. An operating system 24 is loaded into memory 24 for access by the CPU 12. The currency conversion application described herein is stored on a computer readable medium 28 for loading into memory 24. An OCR dictionary 30, for converting the text images to numerical information and currency symbols (e.g., USD $, GBP £, EUR [symbol] , JPY ¥, CNY ¥, INR [symbol] ) is stored on the mobile device 10. A currency database 32 is typically cached on the mobile device 10 for access, especially if no network connection is available. It is understood that the manner of storing the computer readable 28, the operating system 26, the OCR dictionary 30, and the currency database 32 may vary based upon the overall architecture of the mobile device 10.

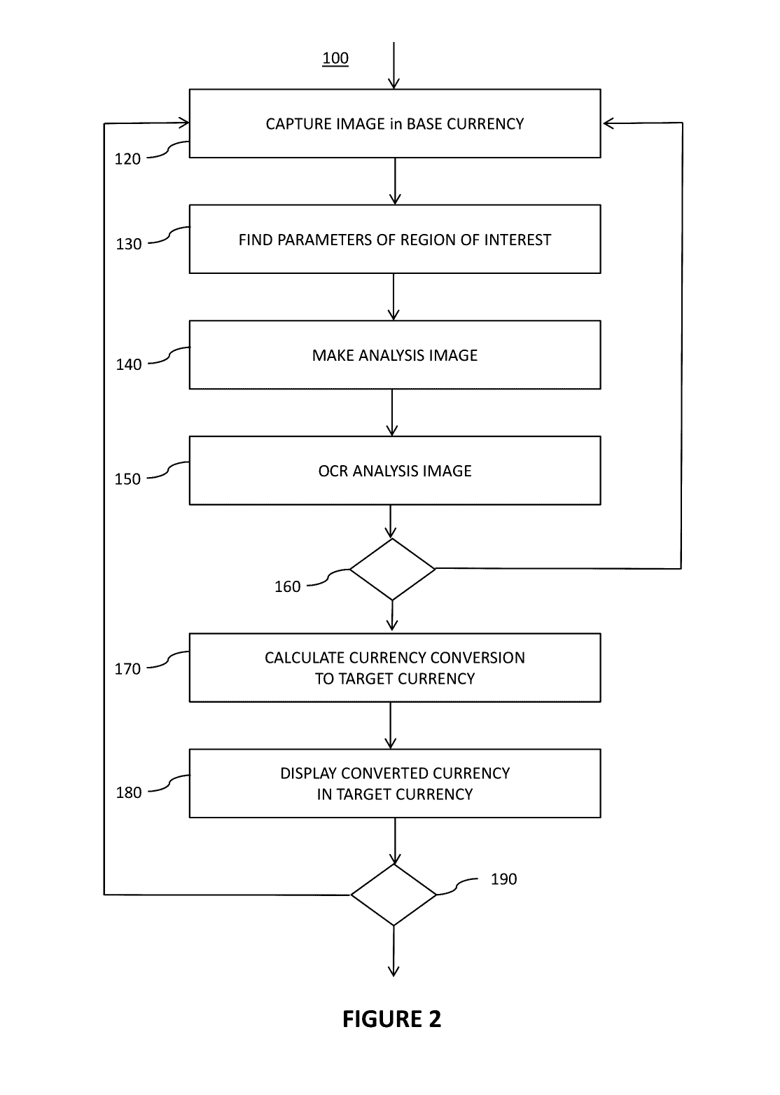

FIG. 2 illustrates an exemplary embodiment of the disclosed subject matter as a technique for providing currency conversion on a mobile device 10. In describing the routine, certain activities or processes may be referred to herein as steps or blocks. Each step may include the execution of instructions on the CPU 12 or parallel processing unit 18. In some cases, each step will include operation of the hardware components of the mobile device 10. Further, various steps may be illustrated as having “paths” connecting them. It is understood that such paths may be merely conceptual in nature and do not exclude the provisional of additional steps occurring between illustrated steps, or the rearrangement of steps.

In some embodiments, the process commences with an initialization process, not shown. For example, at the time that the application is initiated by the user, the processor 12 on the mobile device 10, running the software, can step through various initialization steps. A first step is initialization of the user interface. If this initialization process is successful, the application proceeds to the next phase. If the initialization fails, the application ends in some embodiments. A second step is the initialization of the camera 14 on the mobile device 10. Once again, if this camera initialization process is successful, the application proceeds to the next phase. If the initialization fails, the application ends. A third step is the initialization of the OCR facility on the mobile device. Similarly, if the OCR initialization process is successful, the application proceeds to the next phase. If the initialization fails, the application ends. A fourth step is the initialization of the network components. Initialization is operating system dependent and virtualized. If it is successful, the system uses new exchange rates which are downloaded, and the application proceeds to the next phase. If the initialization fails, the system uses the last exchange rates received with then the user was online. Thus, the system may work even if the user does not have internet access. Once all initialization procedures are completed successfully the application can proceed to the activity scanning, as described below. It is understood that the initialization steps described above may proceed in a different order, and certain steps may be omitted or additional initialization steps added.

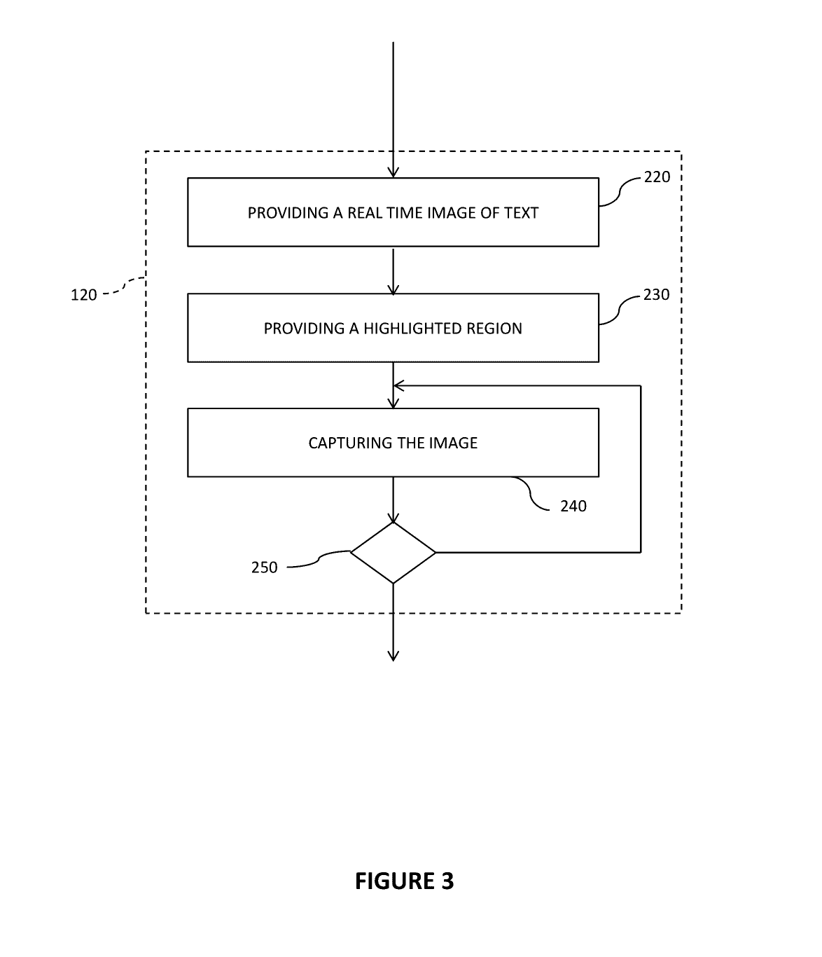

An early step in the process 100 is image capture in the base currency (block 102). Image capture is illustrated in greater detail in FIG. 3. A real-time image of the desired text is provided by the camera 14 on a display 16 of the mobile device 10 (block 220). The desired text is any written representation of a currency value, e.g., a document, a sign, a menu, etc., and may include a currency symbol (e.g., USD $, GBP £, EUR [symbol] , JPY ¥, CNY ¥, INR [symbol] ). A highlighted region is rendered on the display (block 230).

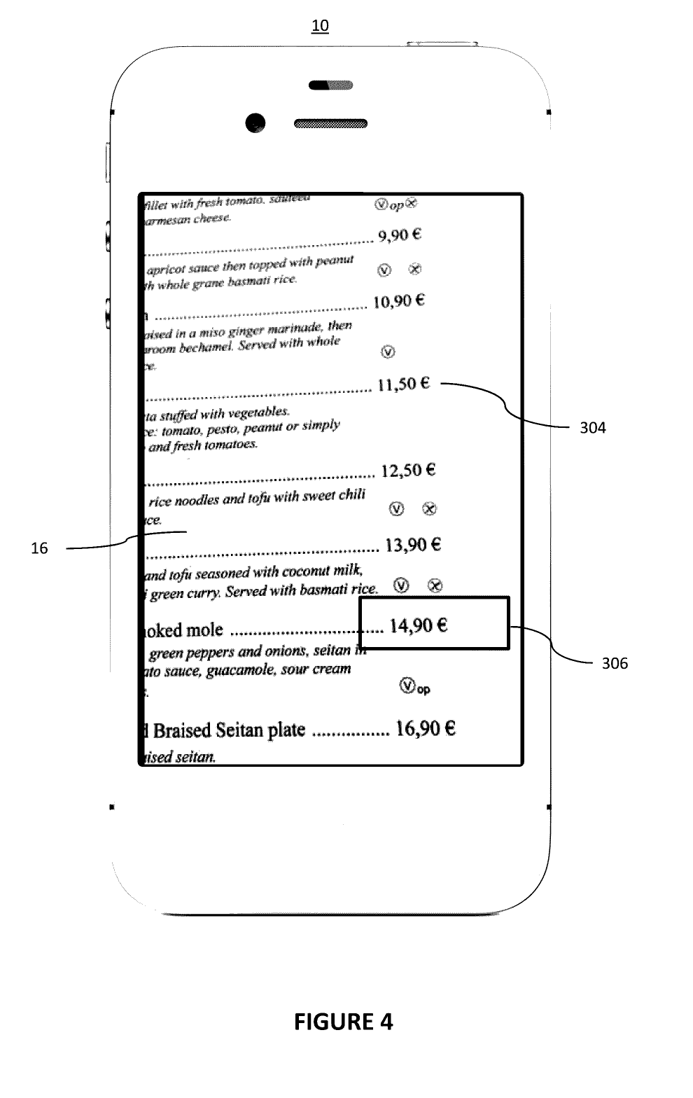

FIG. 4 illustrates a typical mobile device 10, such as a smartphone for use with the described method 100. The mobile device 10 includes a display 16, such as an LCD or OLED display, in which selected text 304 is rendered. In this example, a portion of a menu is displayed on the screen. Also rendered on the display is a highlighted region of text 306. The highlighted region 306 allows the user to select the desired portion of text for currency conversion. In some embodiments, the highlighted area is rendered with a rectangular outline, as shown. Alternatively, the highlighted region could have different intensity or a different color than the background region. In some embodiments, the highlighted region is capable of user selection, in which the user can specify the size or background color of the highlighted region. The user can manipulate the display, e.g., can move it up or down, to the left or right, and/or zoom in or out, in order to position the desired currency representation to be placed within the highlighted region 306. In this example, currency amount subject to conversion is “14.90 [symbol] .”

With continued reference to FIG. 3, an image is captured (block 240), preferably including the currency text within the highlighted region 306. In some embodiments, up to 30 samples every second are received from the camera feed for processing. It is understood that the frame rate depends on such factors as the processing power of device used. A single image from camera input stream is taken into the processing buffer using AV foundation framework. In some embodiments, the application processes all images that come from the camera. The AV Foundation framework has the capability to supply the next captured image in real time when processing of the previous image is completed.

With continued reference to FIG. 2, after the image capture (block 120) is the determination of a “region of interest” (block 130), which is subsequently relied upon for optical character recognition (OCR) and for currency conversion. In some embodiments, image processing is carried out using the OpenCV library, for example. It is understood that other computer vision libraries can be used for this purpose.

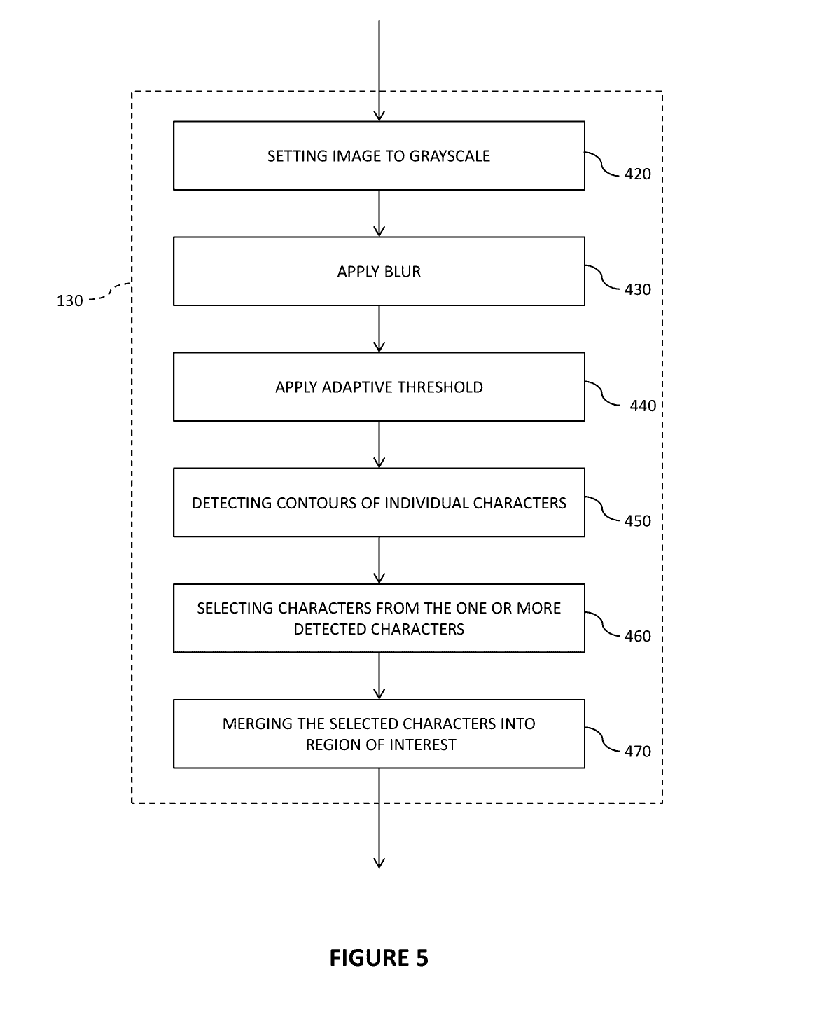

As illustrated in FIG. 5, the captured image is processed in order to facilitate the “region of interest” determination. In some embodiments, the captured image is set to the grayscale spectrum (block 420), e.g., using cvtColor method. In some embodiments, a blur can be applied to the whole image (block 430), e.g., a Gaussian blur, using the GaussianBlur routine of OpenCV. In some embodiments, an adaptive threshold can then be applied (block 440), which converts the grayscale image to a black and white image, e.g., a 1-bit black and white image, thus improving OCR accuracy and speed using adaptiveThreshold routine of OpenCV. It is understood that these steps are useful in optimizing the image, and that other types of image processing may be used in addition to or instead of the techniques described above.

In a subsequent step, the contours of each of the characters of text are detected (block 450) using, e.g., the “findContours” method of OpenCV. In some embodiments, a useful technique is described in Suzuki, S. and Abe, K., “Algorithm for detecting contours,” Topological Structural Analysis of Digitized Binary Images by Border Following. CVGIP 30 1, pp 32-46 (1985).

In another step, a “bounding box” is detected from the array of contours detected above using, e.g., the “boundingRect” method. The OpenCV OCR library, for example, provides that the contours are selected and bounding boxes are created around them in order to reduce image size to be sent for OCR processing (block 460).

In a further step, selected items (e.g., characters) from multiple bounding box arrays are merged into a single bounding box using the following method of OpenCV:

cv::Rect boundingRect(minX,minY,ABS(maxX-minX),ABS(maxY-minY)) [1]

In some embodiments, a bounding box is created for each character. Thus, the minimum and maximum coordinates of all the bounding boxes are being used to form a surrounding “master” bounding box, also referred to as a “region of interest.” The minX, maxX, minY, and maxY coordinates are selected to incorporate the X and Y coordinates of all of the bounding boxes of interest.

With continued reference to FIG. 2, another step in the process is making an analysis image for currency conversion (block 140). In some embodiments, the original captured image is cropped using the coordinates determined by the “region of interest” analysis (block 130). In some embodiments, the original captured image is transposed and flipped and blurred (e.g., using a blur that pixelates image, and a Gaussian blur that makes final smooth image and a regular blur is used because it is much quicker) to be applied as a background for digits.

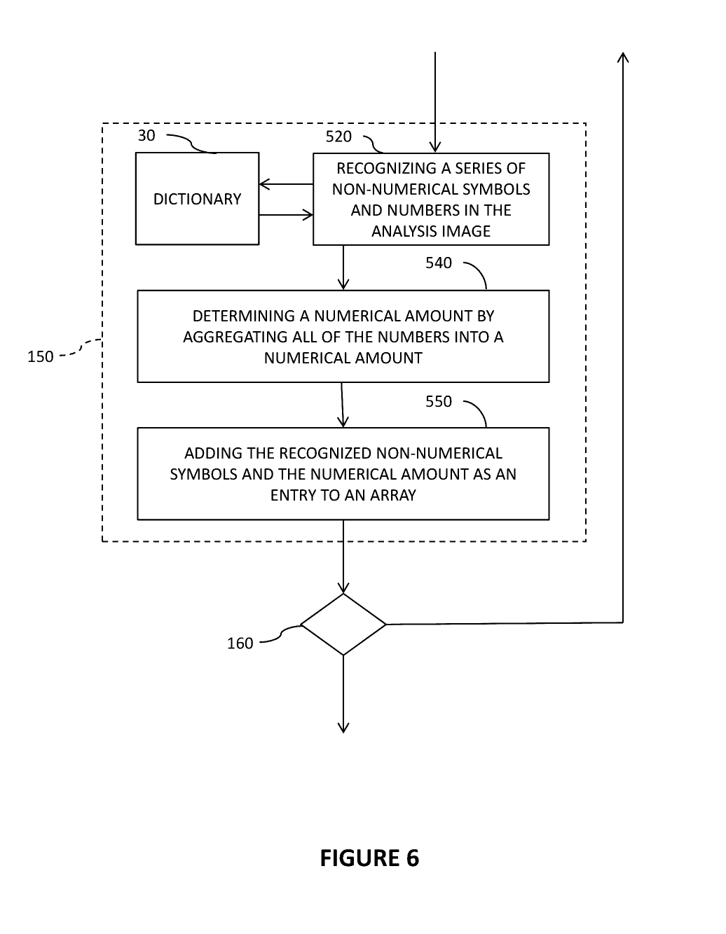

In a next step in the process, the optical character recognition {OCR) procedure is applied to the “analysis image” (block 150). The analysis image, i.e., the original captured image as cropped using “region of interest” coordinates, is provided to an OCR routine. In some embodiments, the “Tesseract” routine is used for OCR recognition. As illustrated in FIG. 6, the OCR routine recognizes a series of non-numerical symbols and numbers within the analysis image (block 520) and relies upon a dictionary 30 for the recognition of numbers and symbols. The OCR routine processes images in separate thread, e.g., by using the parallel processing unit 18, so that the application can start over with taking the next image from the camera stream while continuing with the OCR process. In some embodiments, the OCR routine “blacklists” certain characters using this method:

tesseract->SetVariable(“tessedit_char_blacklist”, “oOIi|1”) [2]

For those characters, e.g., “o” “O” “I” “I” “|” “1” the presumption is that the user is relying on this application for recognizing numbers, and accordingly the context is biased toward such numbers, rather than letters. After performing the OCR procedure on individual numbers, the numerical amount is determined by aggregating all of the number into a numerical amount (block 540). Each of the numerical amounts and non-numerical symbols (e.g., currency symbols USD $, GBP £, EUR [symbol] , JPY ¥, CNY ¥, INR [symbol] ) are added to an array as a string (block 550). The routine then processes the next image (decision block 160). There is a two-second threshold when processing images so the same image is presented for two seconds. The recognized string is added to the array, and every two seconds, the most frequent result is sent to the currency conversion procedure (decision block 160). In some embodiments, the routine keeps track of the most frequently occurring string to send to the conversion procedure. It is understood that other techniques may be used. For example, if the same string is detected three times consecutively, or three times in a series of ten detections, that particular string is advanced to the currency conversion procedure.

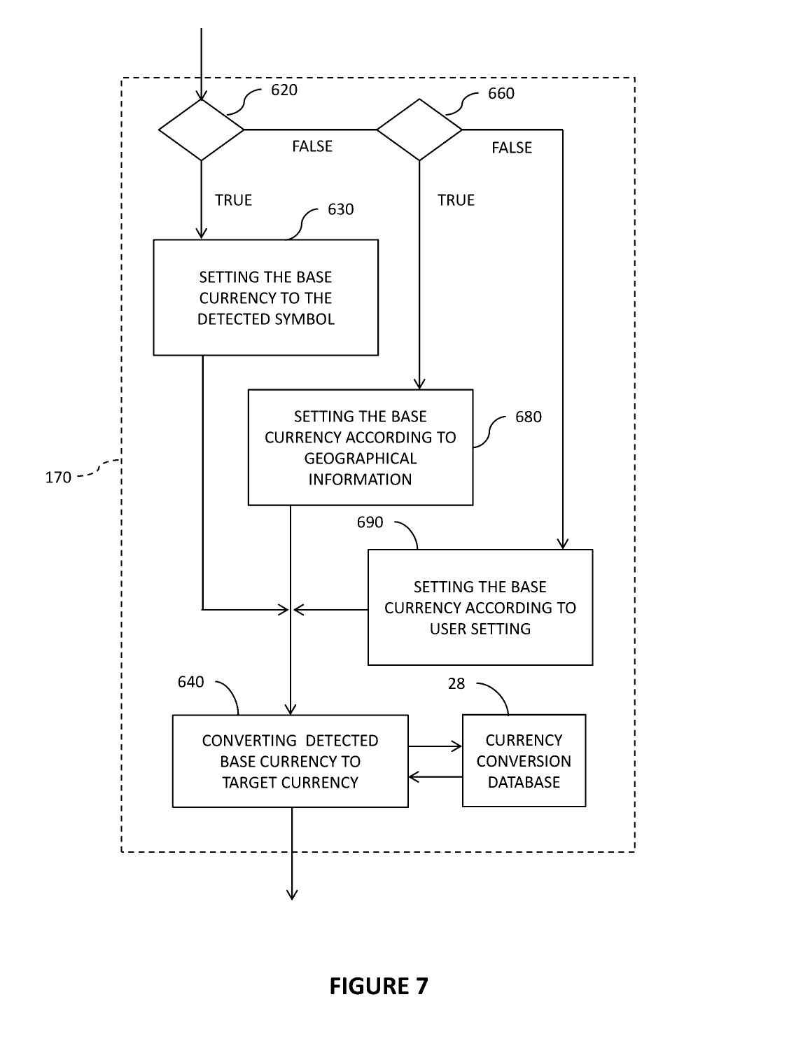

Returning to FIG. 2, the selected character string is provided to the currency conversion procedure (block 170). Further details of the currency conversion are illustrated in FIG. 7. A next step is detecting the base currency of the character string, e.g., the “native” or “local” currency in which the currency representation appeared on the selected document, menu, sign, etc. If the character string contains a currency character among the non-numerical characters (e.g., USD $, GBP £, EUR [symbol] , JPY ¥, CNY ¥, INR [symbol] ) (decision block 620), it will use them as the base currency (block 630). If there is no currency symbol in recognized string, and the application detects geolocation data (decision block 66), the application will use the geographical information to set the base currency (block 680). If neither geographical location nor currency character information is available, the application sets the base currency according to the user selection (block 690).

In some embodiments, the target currency, i.e., the “home” currency of the user, is manually selected by user. The application converts the detected base currency to the selected target currency (block 640). In some embodiments, the currency exchange rates is obtained from a currency conversion database 32, which can be resident on the mobile device 10, or cached in memory 24. Currency exchange rate information is available, e.g., using a public API (openexchangerates.org) which can be loaded in real-time. Alternatively, the information is loaded at the start of the application. Ifs network connection is not available on start, then the application will use latest cached API data. (In some embodiments, the target currency is being calculated using the provided exchange rates, using USD as the main reference currency, because USD is used in exchange rate API as main currency. It is understood that currency exchanges could also be performed from base to target currencies without relying on the USD as a reference currency.)

With continued reference to FIG. 2, the next step is the display of the converted currency on the display screen of the mobile device (block 180).

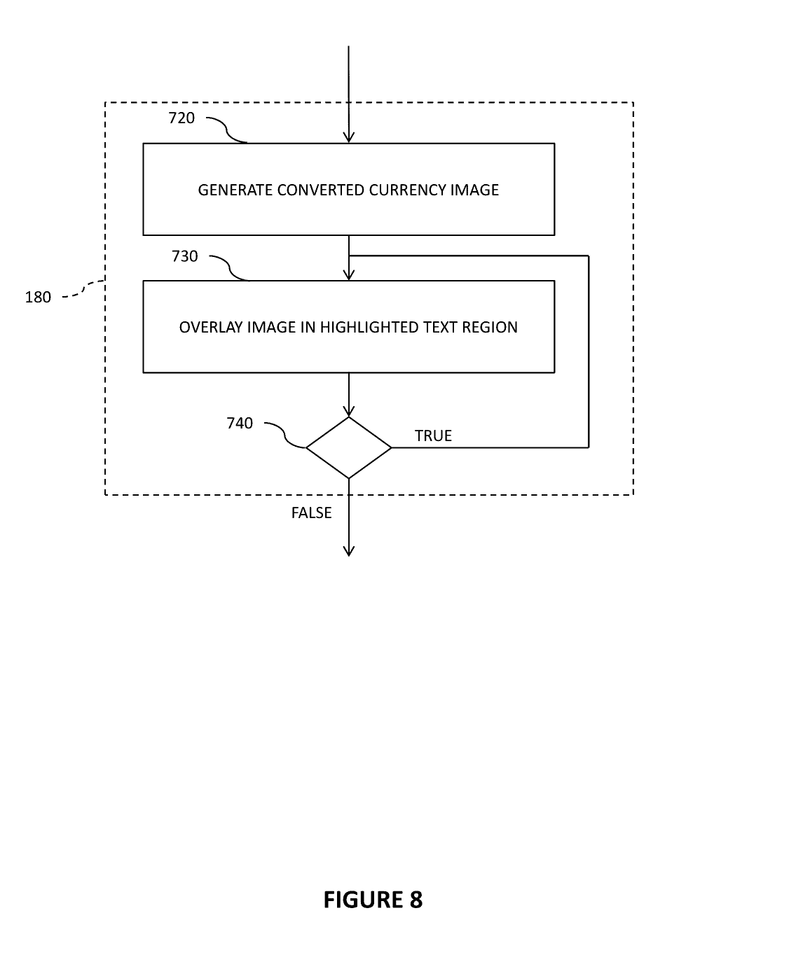

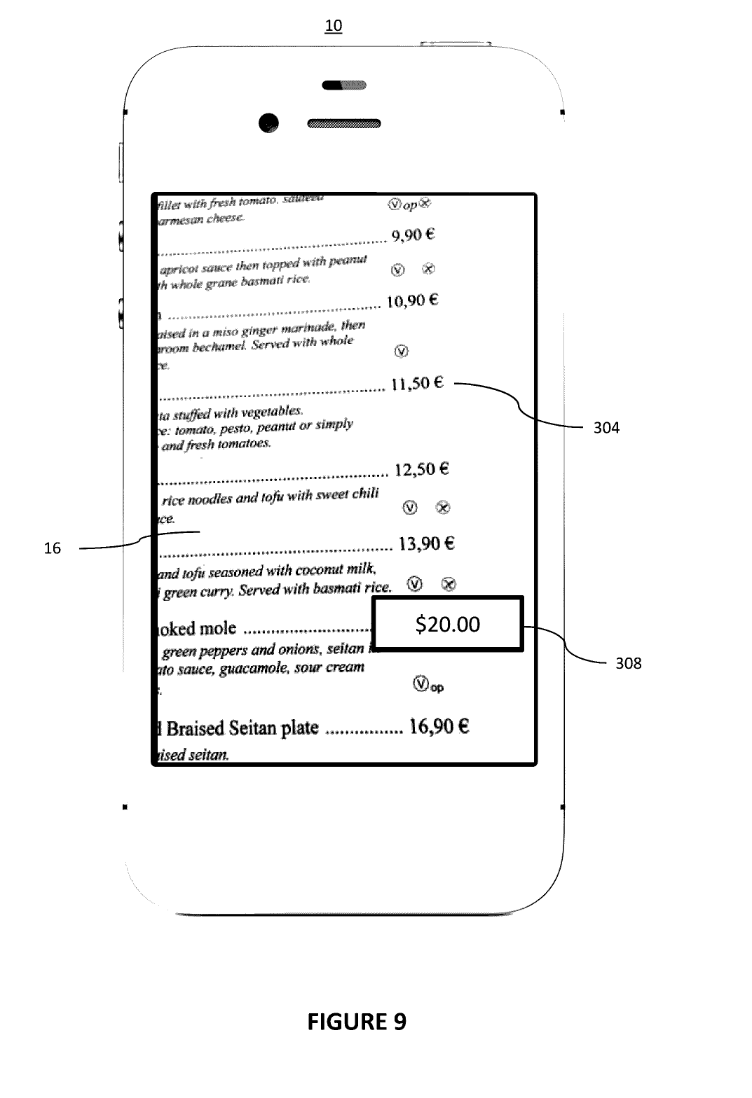

As illustrated in FIG. 8, an overlay subroutine is used in accordance with one embodiment. In block 720, the application generates an overlay image including a background, the converted numerical currency information calculated at block 170, as well as the currency symbol of the target currency (e.g., USD $, GBP £, EUR [symbol] , JPY ¥, CNY ¥, INR [symbol] ), if a corresponding symbol of the base currency was detected in the region of interest. Optionally, the generation of text has similar location within the highlighted region 306 and font characteristics from the original image. During the OCR procedure, information regarding the font size and location may be stored and accessed when generating the overlay image. In some embodiments, the algorithm processes the background and provides a blurred background with average color on which the converted numerical currency information and optional currency symbol are overlaid. In block 730, the application displays the original image frame with the generated overlay obscuring the original currency text. See, e.g., FIG. 9, in which the base currency amount of 14.90 [symbol] has been converted to $20.00, and the overlay image 308 containing the converted currency amount is displayed. If additional currency conversions are requested the application captures new images, or alternatively ends the application (decision block 190).

If the user is reviewing a list of multiple entries, such as the menu in the example discussed in FIGS. 4 and 9, the user may rapidly obtain a conversion for one entry, and then quickly move on to obtain the conversion information for another entry, and so on. The overlay of the converted text is particularly helpful as a “place holder” to remind the user for which entry a currency conversion is being sought.

The operation allows for substantially one-handed operation, since the user highlights the region of interest, and the software can calculate the conversion with no further intervention.

While the disclosed subject matter is described herein in terms of certain exemplary embodiments, those skilled in the art will recognize that various modifications and improvements may be made to the disclosed subject matter without departing from the scope thereof.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations.

It will be apparent to those skilled in the art that various modifications and variations can be made in the method and apparatus of the disclosed subject matter without departing from the spirit or scope of the disclosed subject matter. Thus, it is intended that the disclosed subject matter include modifications and variations that are within the scope of the appended claims and their equivalents.

1. An information processing method running on a mobile device for converting a textual representation of a currency amount from a base currency to a target currency, comprising:
(a) capturing an image of text including a currency amount by an image capturing device of the mobile device from a selected region in a larger portion of text displayed on the display;
(b) determining, by the mobile device, the parameters of a region of interest by detecting one or more contours of individual characters located in the captured image;
(c) defining an analysis image, by the mobile device, by selecting a portion of the captured image using the parameters of the region of interest;
(d) recognizing in the analysis image, by the mobile device via optical character recognition, a series of non-numerical symbols and numbers;
(e) adding, by the mobile device, the recognized non-numerical symbols and the numbers as an entry in an array;
(f) repeating steps (a)-(e) and selecting one of the entries from the array;
(g) converting, by the mobile device, the numerical amount from the base currency to the target currency; and
(h) overlaying in the selected region, the converted numerical amount in the target currency.

2. The information processing method of claim 1, wherein the selected base currency is determined by recognition of a currency symbol in the non-numerical symbols.

3. The information processing method of claim 1, wherein the selected base currency is selected by the user.

4. The information processing method of claim 1, wherein the selected base currency is selected by geolocation data.

5. The information processing method of claim 1, wherein the target currency is selected by the user.

6. The information processing method of claim 1, wherein the image is a frame of a real-time video stream.

7. The information processing method of claim 1, further comprising providing a highlighted region on the display for a user to select a region in a larger portion of text.

8. The information processing method of claim 7, wherein providing the highlighted region on the display comprises allowing a user to manipulate the display to position a selected portion of text within the highlighted region.

9. The information processing method of claim 7, wherein the highlighted region is a fixed area.

10. The information processing method of claim 7, wherein the highlighted region is user-selectable area.

11. The information processing method of claim 1, wherein the recognizing, by the mobile device via optical character recognition, a series of non-numerical symbols and numbers in the analysis region comprises providing a subset of characters for conversion to numbers.

12. The information processing method of claim 1, wherein the selecting one of the entries from the array comprises selecting the entry having the greatest frequency in the array.

13. An information processing method for converting a textual representation of a currency amount from a base currency to a target currency, comprising:
(a) providing, on a display of a mobile device, a real-time image of text including a currency amount and a highlighted region on the display for a user to select a portion of the text;
(b) capturing an image including at least the highlighted region of the display with an image capturing device;
(c) detecting, by the mobile device, one or more contours of individual characters located in the captured image;
(d) selecting, by the mobile device, one or more characters from the one or more detected characters and merging the selected characters into a region of interest;
(e) defining an analysis image, by the mobile device, by selecting a portion of the captured image using the parameters of the region of interest;
(f) recognizing in the analysis image, by the mobile device via optical character recognition, a series of non-numerical symbols and numbers;
(g) adding, by the mobile device, the recognized non-numerical symbols and numbers as an entry in an array;
(h) repeating steps (a)-(g) and selecting one of entries from the array;
(i) if the recognized non-numerical symbols correspond to a currency type, establishing the base currency as the currency type, and converting, by the mobile device, the numerical amount from the base currency to the target currency;
(j) overlaying in the highlighted region on the display, the converted numerical amount in the target currency.

14. The information processing method of claim 13, wherein the image is a frame of a real-time video stream.

15. The information processing method of claim 13, wherein providing a highlighted region on the display comprises allowing a user to manipulate the display to position a selected portion of text within the highlighted region.

16. The information processing method of claim 13, wherein the highlighted region is a fixed area.

17. The information processing method of claim 13, wherein the highlighted region is user-selectable area.

18. The information processing method of claim 13, wherein the recognizing, by the mobile device via optical character recognition, a series of non-numerical symbols and numbers in the analysis region comprises providing a subset of characters for conversion to numbers.

19. The information processing method of claim 13, wherein the selecting one of the entries from the array comprises selecting the entry having the greatest frequency in the array.

20. The information processing method of claim 13, wherein the determining by the mobile device whether the recognized non-numerical symbols correspond to a currency type comprises comparing the non-numerical symbols to a library of currency symbols.

21. The information processing method of claim 13, wherein the selected base currency is selected by the user.

22. The information processing method of claim 13, wherein the selected base currency is selected by geolocation data.

23. The information processing method of claim 31, wherein the target currency is selected by the user.

24. A mobile device, comprising:
an image capturing device;
a display;
one or more processors; memory; and one or more programs,
wherein the one or more programs are stored in the memory and configured to be executed by the one or more processors, the one or more programs including instructions for:
capturing an image of text including a currency amount by the image capturing device of the mobile device from a selected region m a larger portion of text displayed on the display;
determining the parameters of a region of interest by detecting one or more contours of individual characters located in the captured image;
defining an analysis image by selecting a portion of the captured image using the parameters of the region of interest;
recognizing in the analysis image via optical character recognition a series of non-numerical symbols and numbers;
adding the recognized non-numerical symbols and the numbers as an entry in an array;
repeating the capturing, determining, defining, recognizing, and adding steps and selecting one of the entries from the array;
converting the numerical amount from the base currency to the target currency; and
overlaying in the selected region of the display, the converted numerical amount in the target currency.
